(19) United States
(12) Patent Application Publication
(10) Pub. No.: US 2013/0037002 A1
(43) Pub. Date: Feb. 14, 2013

(54) In-cylinder emission cleaning by cams with auxiliary-lobes

(71) Applicants: Zoltan A. Kemeny, Tempe, AZ (US); Albert Fekete, Winterthur (CH)

(72) Inventors: Zoltan A. Kemeny, Tempe, AZ (US); Albert Fekete, Winterthur (CH)

(21) Appl. No.: 13/199,933

(22) Filed: Sep. 14, 2011

Related U.S. Application Data
(60) Provisional application No. 61/575,535, filed on Aug. 24, 2011.
(60) Provisional application No. 61/575,318, filed on Aug. 19, 2011.
(60) Provisional application No. 61/574,803, filed on Aug. 11, 2011.

(51) Int. Cl. F02B 75/00; F02B 75/02

(52) U.S. Cl. 123/434

(57) ABSTRACT

Disclosed is an internal combustion engine gas cycle modification process, comprising venting, which allows for some automatic gas transfer from intake to exhaust or vice versa, through the cylinder, in the compression or expansion strokes, by a second or third opening of either the intake or the exhaust valves, which is done by using a second or third auxiliary lobe on the intake or the exhaust cams, which however are much smaller than the normal lobes. Seven gas cycle modifications are explained and compared, each of which reduces NOx by 300-9,000× and cleans emission in the cylinder. On the same fuel consumption, all these modified gas cycles preserve torque and power. One however, increases high engine speed power and torque by over 70%. That may be exchanged for fuel savings. Double and triple lobe cams made the same way and cost the same as single lobe cams. It substitutes after-treatments.

### CROSS-REFERENCE TO RELATED APPLICATION

This application claims the benefits of U.S. Provisional Patent Application Ser. Nos. 61/575,535 of Priority Date Aug. 24, 2011, and 61/575,318 of Aug. 19, 2011 and 61/574,803 of Aug. 11, 2011.

### FIELD OF THE INVENTION

This invention relates to in-cylinder NOx reduction and emission cleaning with altered gas cycle for internal combustion engines. More specifically, to internally venting the cylinder gas in-compression and/or in-expansion to quench and/or dilute the combustion respectively and to boost the effective expansion-to-compression ratio for higher efficiency or fuel savings by valve timing alone, using modified cam profiles, which opens more than once in a complete gas cycle of intake, compression, expansion (power) and exhaust.

### BACKGROUND OF THE INVENTION

Well known are the Otto (1867), Atkinson (1882), Diesel (1893) and Miller (1940) gas cycles, used in internal combustion engines today. Basic cycles are the Otto (spark ignition) and the Diesel (compression ignition) cycles. The Atkinson cycle is a modified Otto cycle, though its technique (late intake valve closing) is also applicable to the Diesel cycle. The Miller cycle is another modified Otto cycle, though its technique (early intake valve closing) is also applicable to the Diesel Cycle. The purpose of these historical modifications was to shorten the effective compression phase to improve thermal efficiency. Back then, emission control was not a serious consideration just yet.

Today the Miller cycle is proposed by some, to reduce NOx emission in Diesel engines. The price of that reduction is great torque and even greater power losses. Yet, in many applications, in-cylinder emission-cleaning is preferable over expensive and complex after-treatment exhaust-gas-cleaning and external exhaust-gas-recycling (EGR) techniques. At low engine load and speed, the Atkinson cycle also reduces NOx, but at high loads and speeds it greatly increases it. For that reason, the otherwise more efficient Atkinson cycle is not used for emission cleaning.

It would be preferable to reproduce, or even to improve upon, the NOx reduction capacity of the Miller and/or the Atkinson cycles, but without significant losses in engine performance or even with some gains in power and torque—at least in the critical or frequent engine load and speed ranges. It would also be preferable that such a new technique would be applicable to both the Otto and the Diesel engines, whether these are four-stroke or two-stroke engines. Finally, it would be preferred that the improvement would quench and/or dilute combustion with internal automatic cooling and/or exhaust gas recycling (EGR).

It would be preferable as well, to keep the new technology simple, with the least disturbance to common engine building practices, such as, for instance, using a small second and/or third lobe on a cam. The new technique should call for minor alterations at marginal cost. Yet, the solution should provide compliance capability with the most stringent emission regulations worldwide. The proposed solution shall be applicable to old engine retrofitting and new engine building, for instance, by simply regrinding or replacing existing or common camshafts. Its benefits shall outweigh its drawbacks.

It is the object of this invention to provide for a simple, economical solution, which overcomes at least the cited difficulties and satisfies the desired operations, with overwhelming advantages versus negligible drawbacks, without disrupting current engine manufacturing technology.

### SUMMARY OF THE INVENTION

The above problems and others are at least partially solved and the above objects and others realized in a process, which according to the teachings of this invention, comprises a venting valve action of the exhaust valve, which partially vents the cylinder gas upon the intake valve closure, whereupon the vented gas is added to the exhaust gas through the cylinder. Alternatively, a venting valve action of the intake valve may partially vent the cylinder gas upon the exhaust valve opening, whereupon, through the cylinder, vented exhaust gas is added to the intake gas. Furthermore, a venting valve action of the intake valve may partially vent the intake gas-in-compression, to the intake manifold. Finally, these alternative venting techniques may be combined. The first venting technique quenches, while the second one dilutes combustion, and the third one cools the charge. Each one reduces NOx, other emissions, and cylinder gas temperature and pressure at different extent. This venting is controlled by a second opening of the intake or the exhaust valve or both. This second opening however is brief and has small valve lift. A third valve opening is also feasible.

It shall be obvious that at least one of these techniques has similar effects to that of the Atkinson and Miller cycles. Yet, it is different and more beneficial. In particular, it also shortens the effective compression phase and thus, by increasing the expansion-to-compression ratio, boosts thermal efficiency. Though, just as the Atkinson and Miller cycles do, this altered gas cycle also loses some intake charge, yet its combustion quenching is superior to these two historical gas cycles. It reduces NOx greatly while preserving or increasing torque and power. It separates the in-cylinder intake-charge cooling from the intake valve trimming, thus it is highly tunable. By the venting gas recycling, these benefits are further enhanced.

It shall also be obvious however that one shall not dump air-fuel-mixture into the exhaust line or into the environment. It is thus preferable to inject fuel (diesel oil or gasoline) after the venting, that is, to use direct in-cylinder fuel-injection instead of carburetor. Alternatively, a reed valve in the intake line may retain the recycled mix. A reed valve in the exhaust line may increase the retention time of the air, vented into the exhaust line, which enhances oxidation and further emission cleaning thereof. Such check valves also help boosting gas cycle performance, when used in multi cylinder engines. The intake reed valve shall be placed before the intake manifold, while the exhaust reed valve, after the exhaust manifold. These check valves shall have low resistance.

Finally, it shall be also obvious that these proposed processes need only a minor modification to current engines. Double or triple lobes (auxiliary lobes) are made the same way as single lobes and cost the same.

For being the most economical and least disruptive solutions for the stated problems, the gas cycle modifications using double and triple lobe cams will be disclosed in detail. Added venting valve solutions will be left as obvious solutions over the teachings of this invention.

### BRIEF DESCRIPTION OF THE DRAWINGS

Referring to the drawings:

FIGS. 1A-1-1A-4 illustrate the State-Of-Art four strokes of an internal combustion engine for reference.

FIGS. 1B-1-1B-4 illustrate the compression-to-intake venting by a second intake valve opening.

FIGS. 1C-1-1C-4 illustrate the compression-to-exhaust venting by a second exhaust valve opening.

FIGS. 1D-1-1D-4 illustrate the expansion-to-intake venting by a second intake valve opening.

FIGS. 1E-1-1E-4 illustrate a combination of the techniques illustrated in FIGS. 1C-1-1C-4, and FIGS. 1D-1-1D-4.

FIGS. 1F-1-1F-4 illustrate a combination of the techniques illustrated in FIGS. 1B-1-1B-4, and FIGS. 1D-1-1D-4.

FIG. 2B through 2F illustrate triple and double lobe cams, suitable for the modified gas cycles proposed.

FIG. A1 illustrates valve lifts and valve gas flow rates vs. crank angle plots for gas Cycle A.

FIG. B1 through B8 illustrate the performances of gas Cycle B.

FIG. C1 through C8 illustrate the performances of gas Cycle C.

FIG. D1 through D8 illustrate the performances of gas Cycle D.

FIG. E1 through E8 illustrate the performances of gas Cycle E.

FIG. F1 through F8 illustrate the performances of gas Cycle F.

FIG. I1 through I8 illustrate the performances of gas Cycle I.

FIG. J1 through J8 illustrate the performances of gas Cycle J.

### DETAILED DESCRIPTION OF A PREFERRED EMBODIMENT

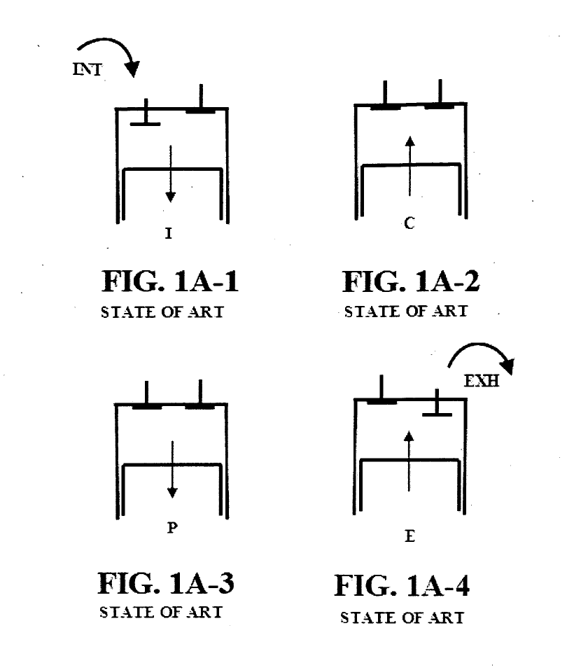

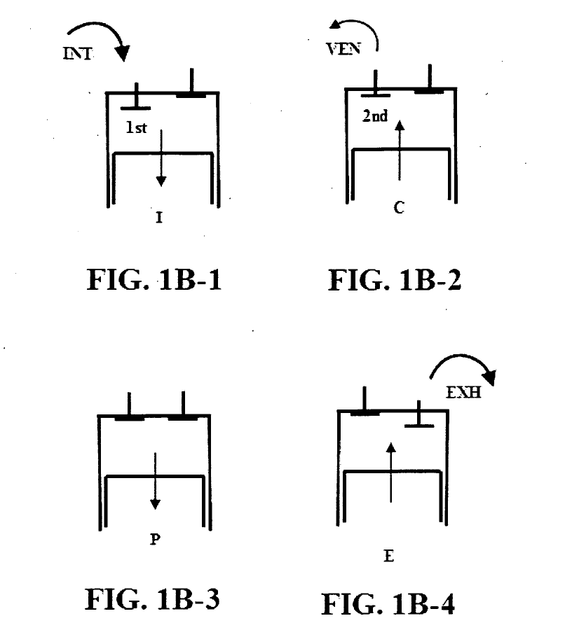

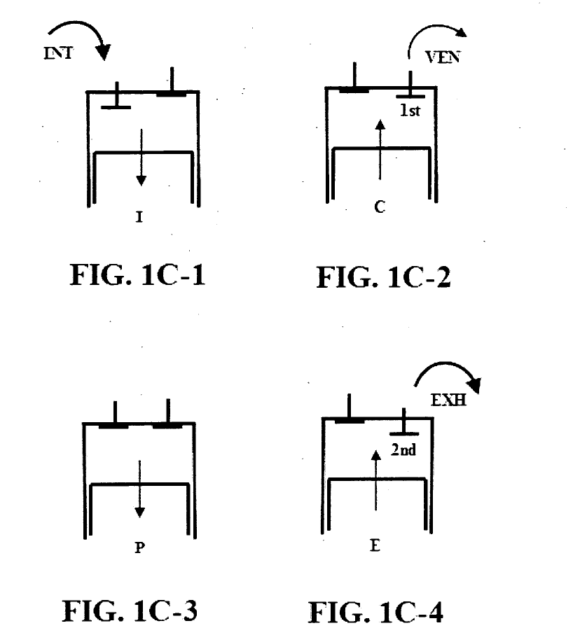

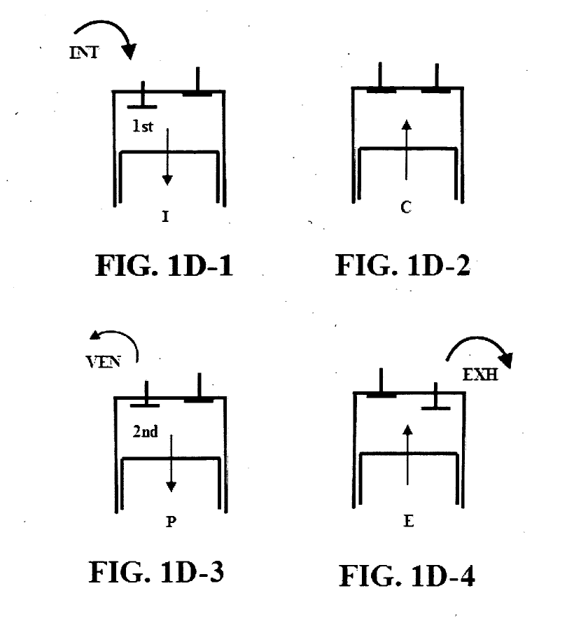

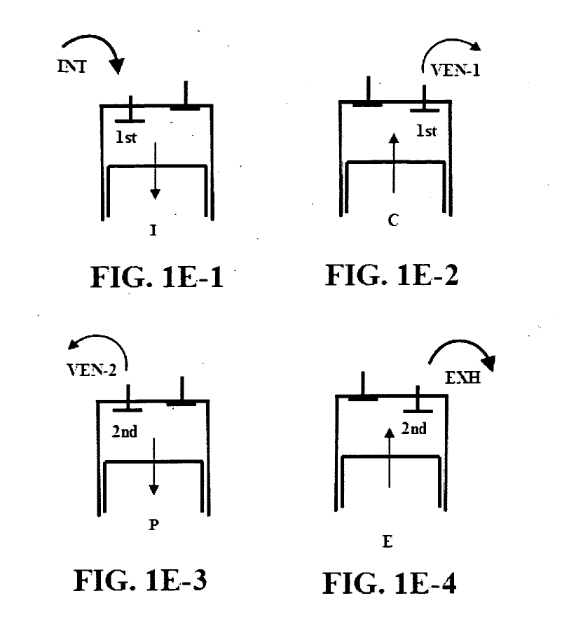

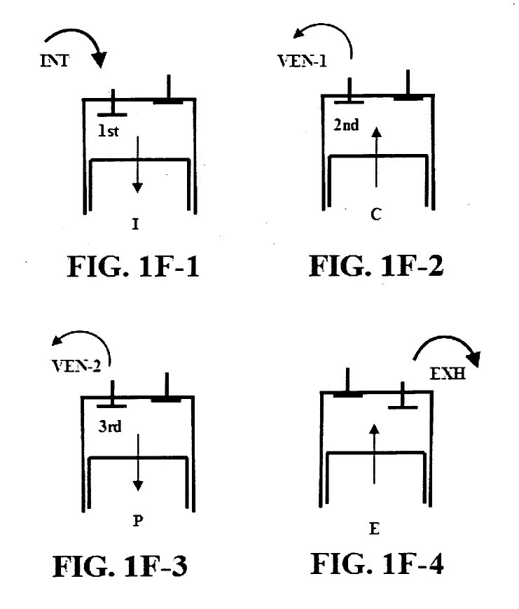

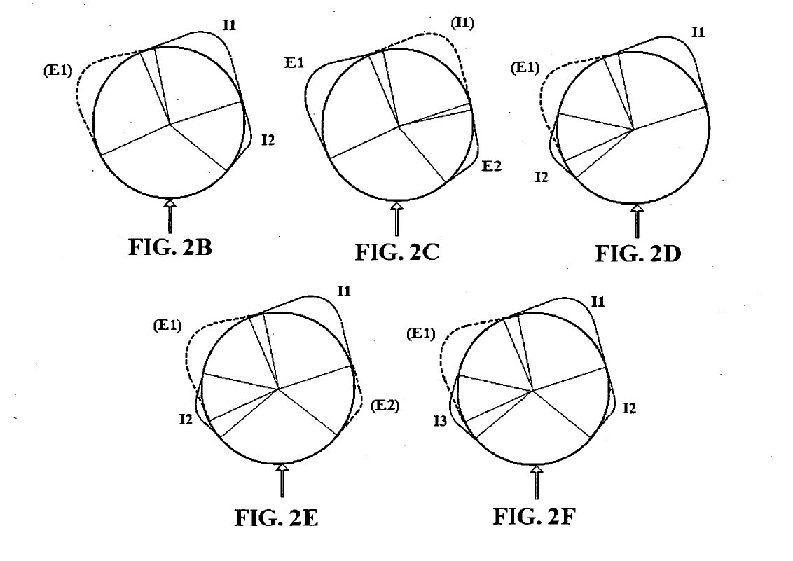

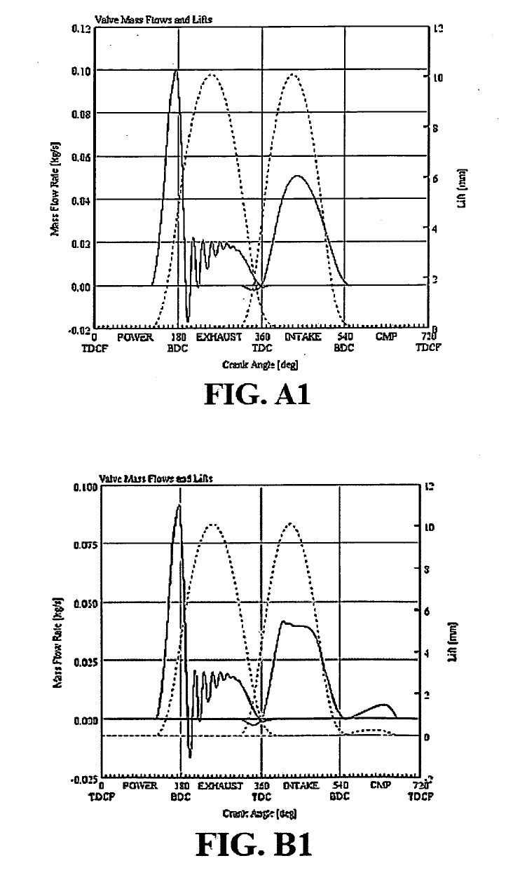

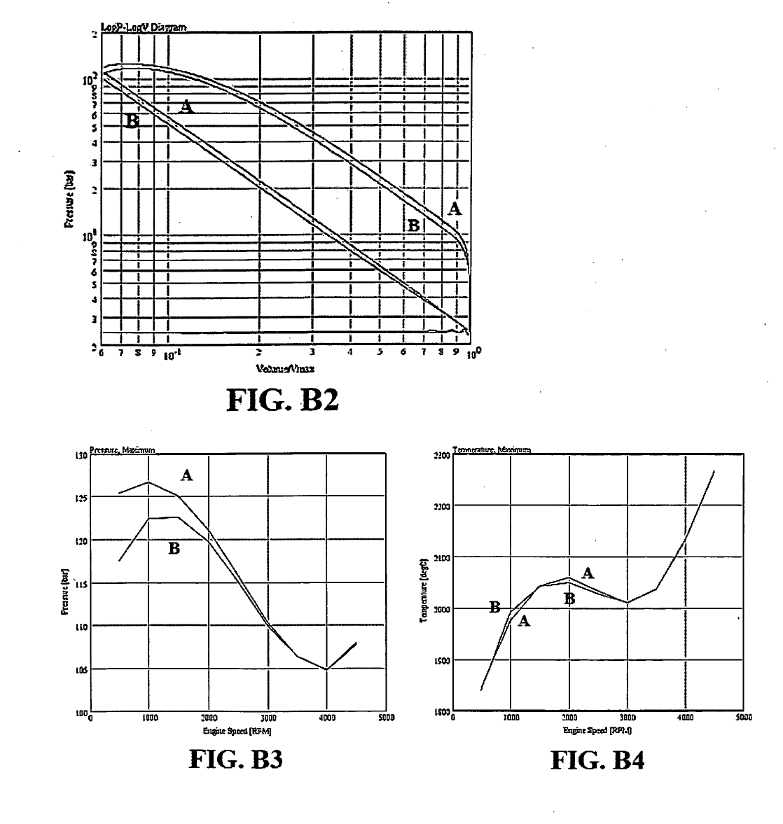

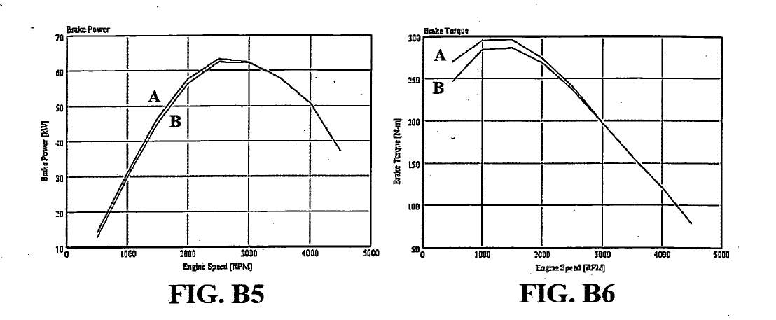

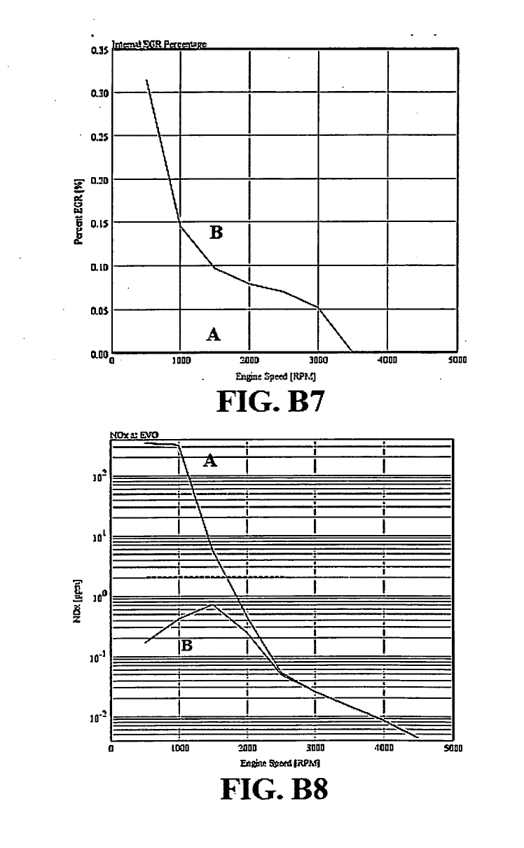

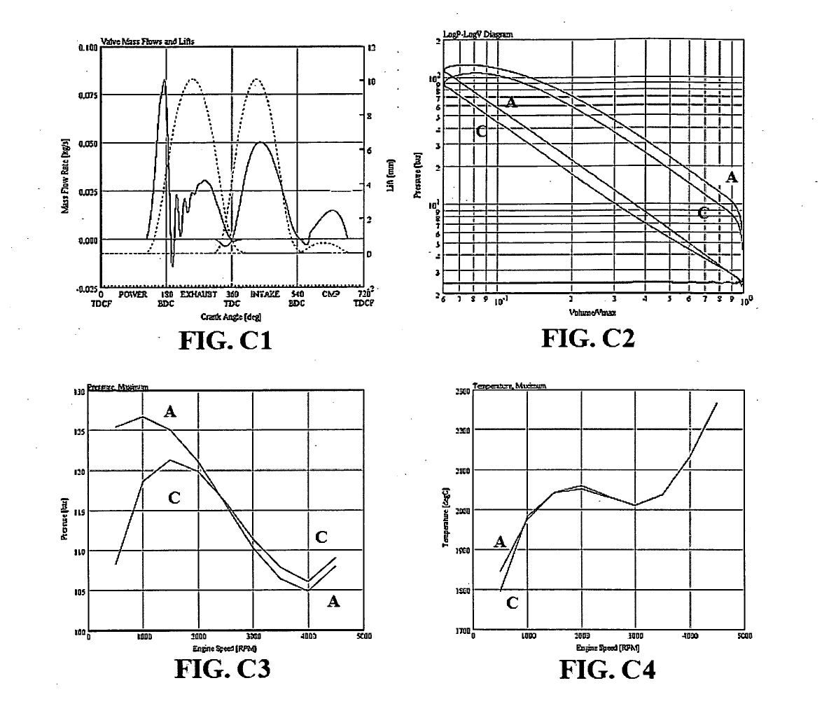

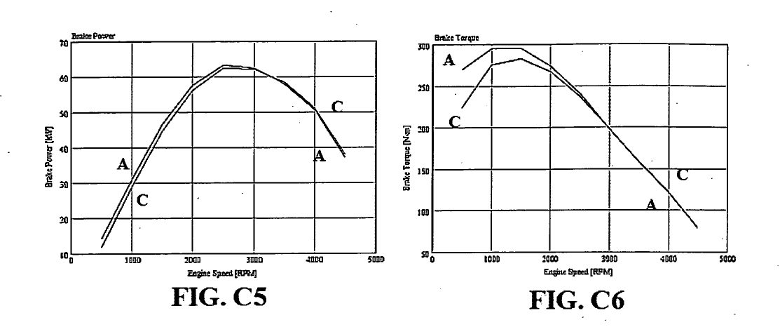

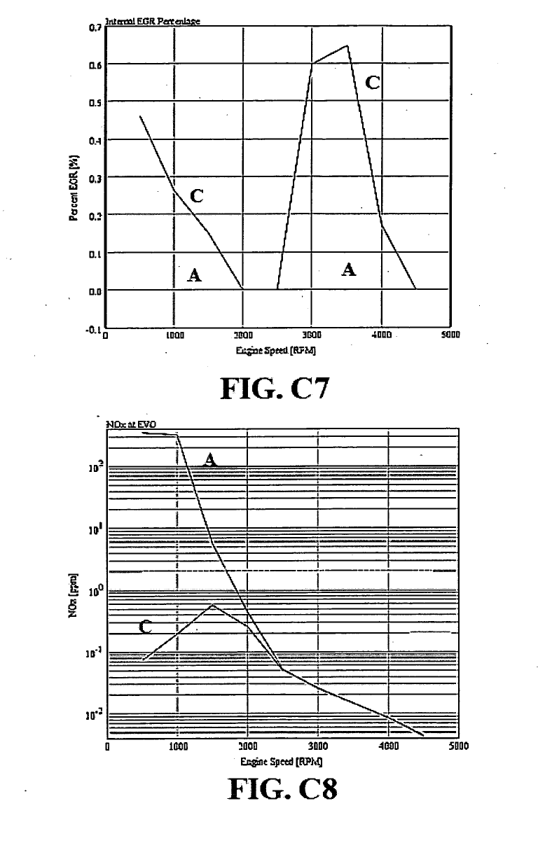

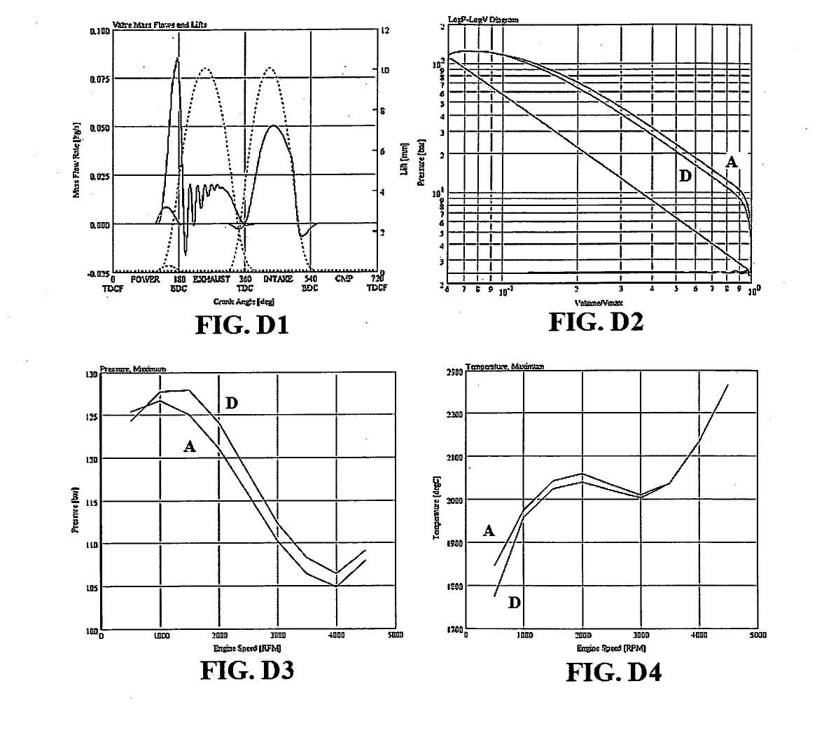

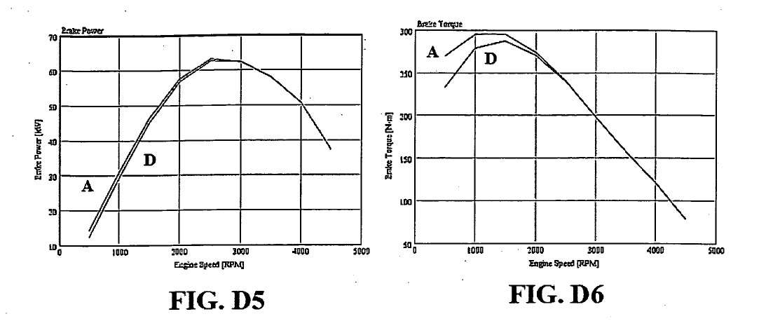

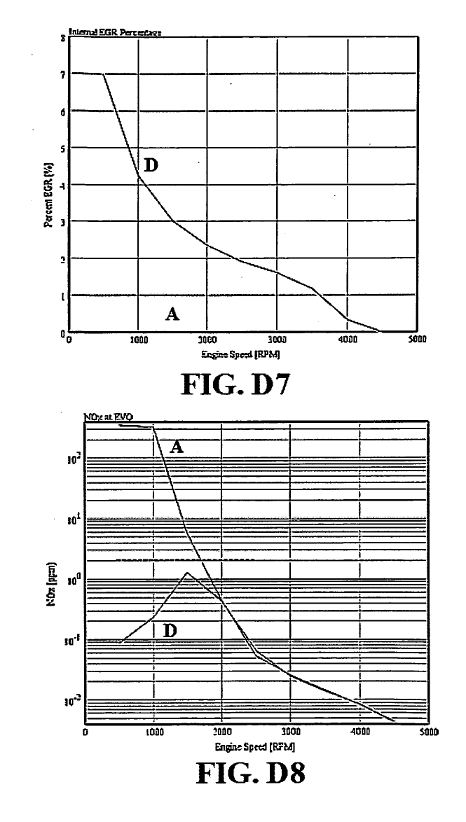

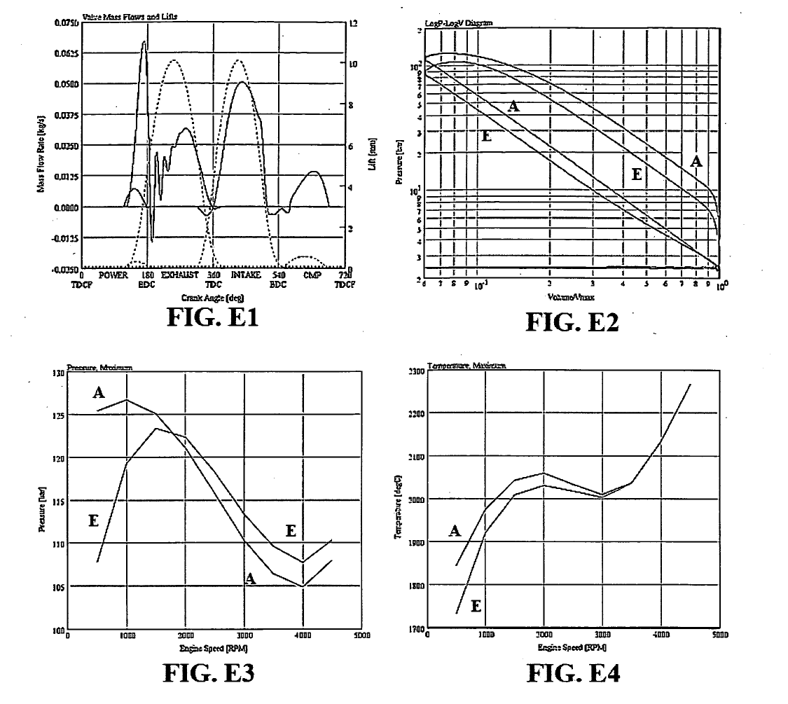

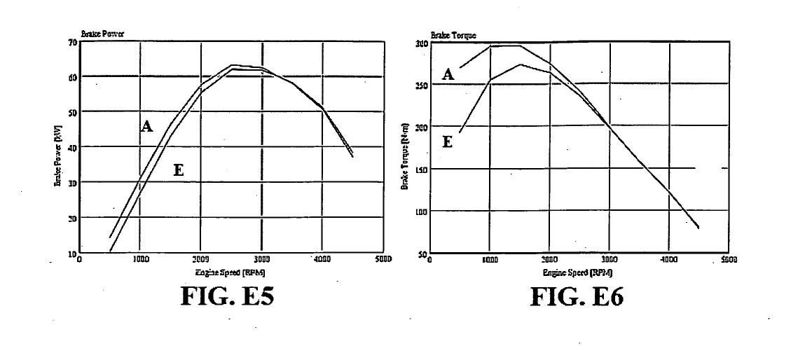

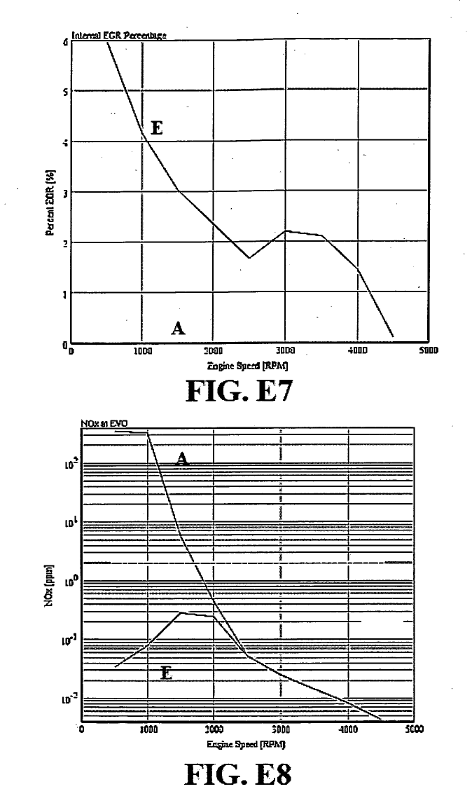

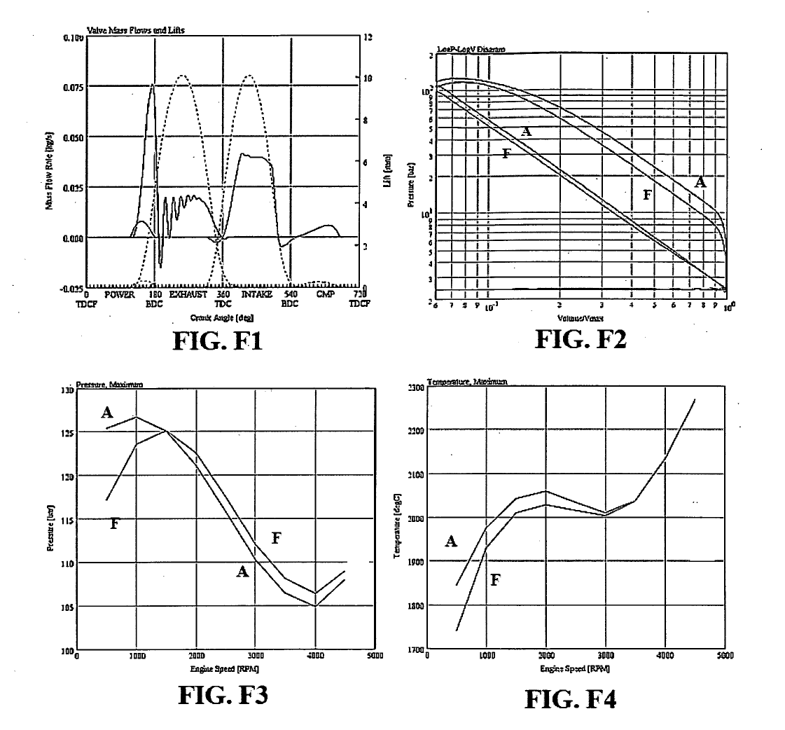

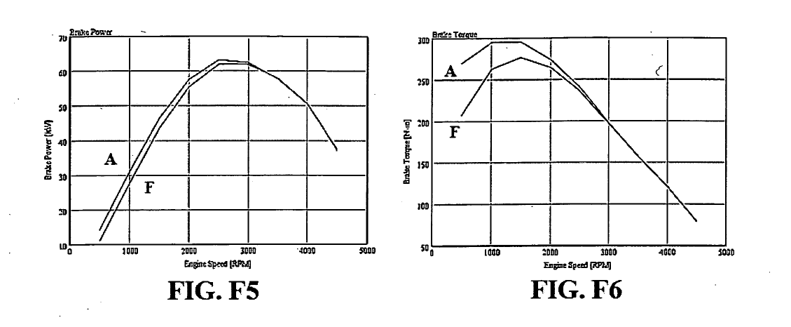

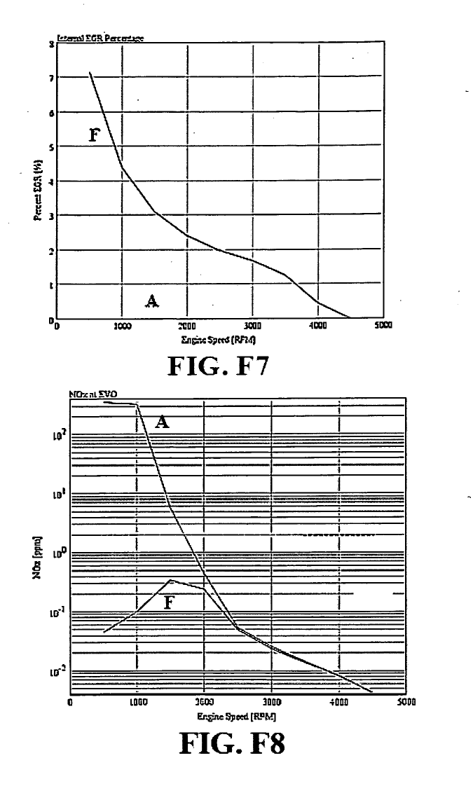

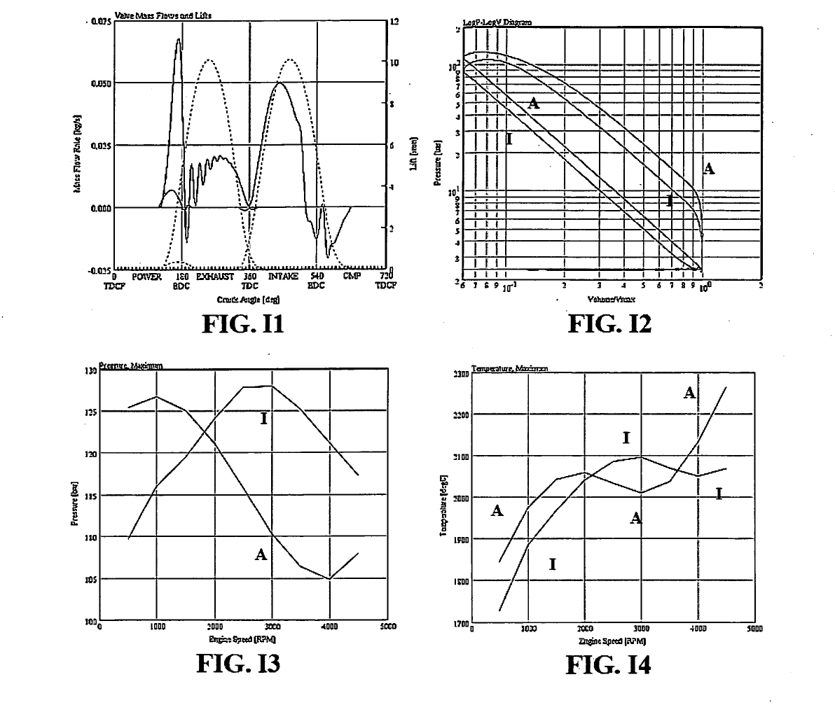

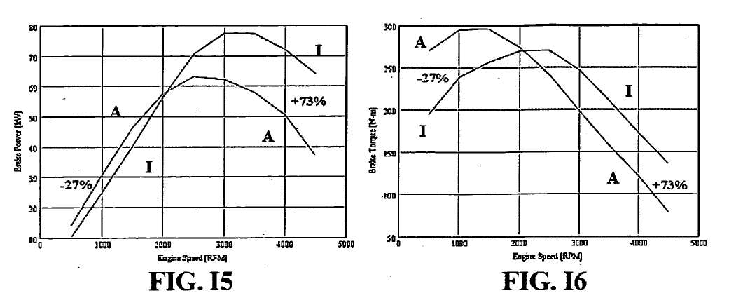

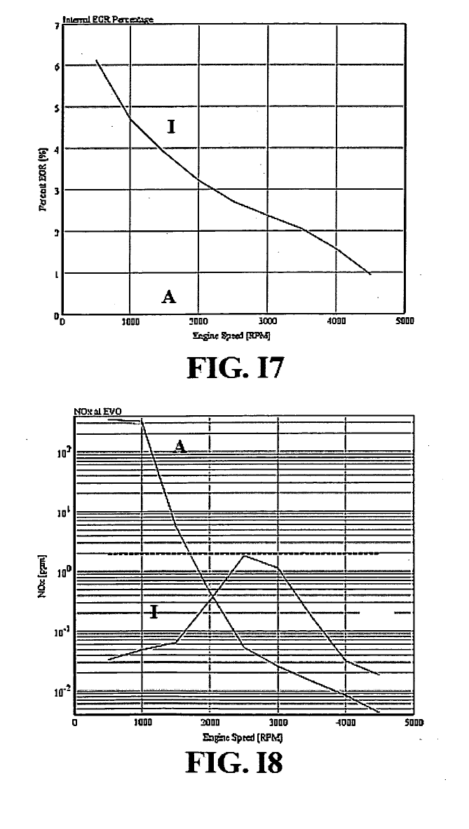

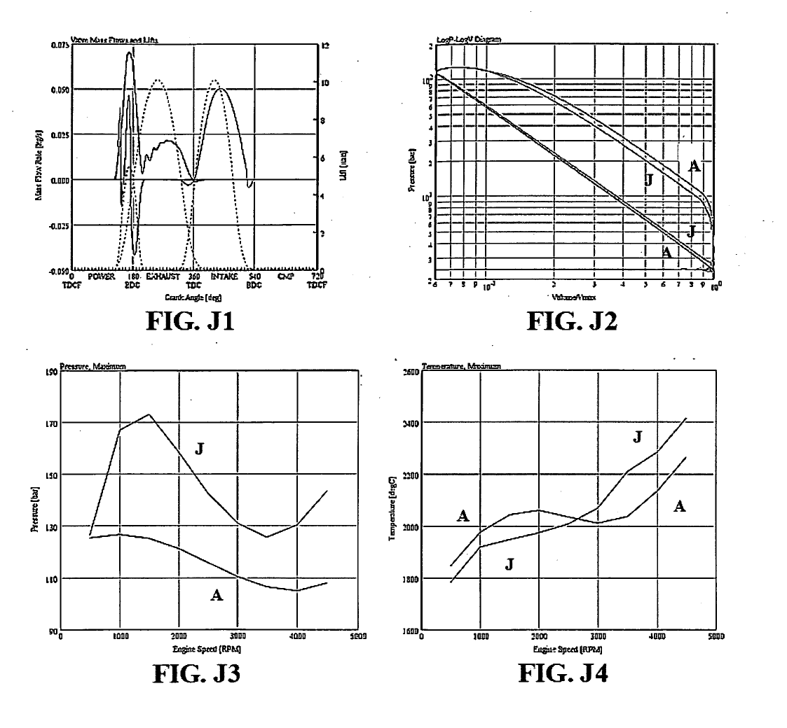

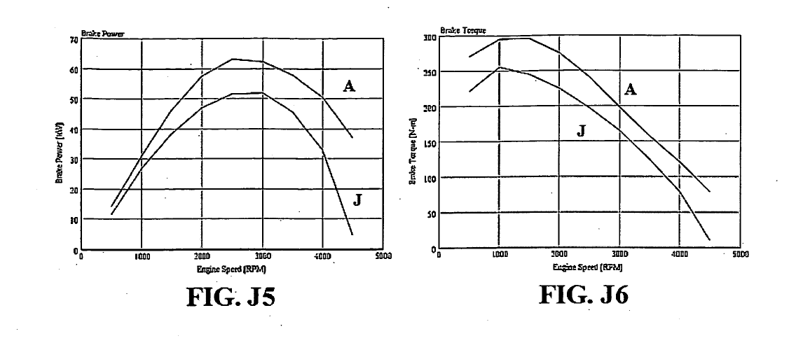

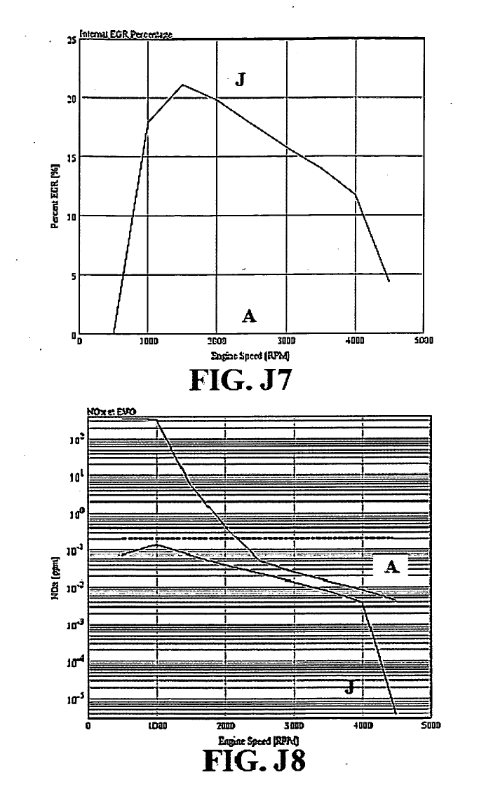

Attention is turned to FIGS. 1A-1-1A-4, which illustrate the state-of-art four strokes of an internal combustion engine. These, in the sequence of operation, are the Intake I in FIG. 1A-1, the Compression C in FIGS. 1A-2, the Power P in FIG. 1A-3 and the Exhaust E in FIG. 1A-4. The intake gas—charged into the cylinder—is labeled INT in FIG. 1A-1 and the exhaust gas—discharged from the cylinder—is labeled EXH in FIG. 1A-4. The intake valve opens once in the intake phase and the exhaust valve opens once in the exhaust phase normally, that is all along the intake and exhaust strokes correspondingly.

In the followings, this normal operation will be referenced as gas Cycle A of a diesel engine. All the proposed gas cycle modifications (B, C, D, E, F, I and J) will describe Diesel cycles thereof. However, all are applicable to Otto cycles as well, with the restriction of not to vent air-fuel-mixture into the exhaust manifold, and not to let it escape from the intake manifold, but rather retained by a low resistance reed valve or other means. Further restriction may include not igniting prematurely that mix with hot exhaust gas vented into it. Though such venting passes through a small valve-gap under high pressure, which by the Venturi effect cools the venting gas, knocking avoidance is needed, which, without electronic controls, at some engine speeds and loads, could still be a challenge.

The Atkinson cycle, Cycle G, is the same as Cycle A, but with intake valve closing late in the compression stroke.

The Miller cycle, Cycle H, is the same as Cycle A, but with intake valve closing early in the intake stroke.

Attention is now turned to FIGS. 1B-1-1B-4, which, according to the teachings of this invention, illustrate the compression-to-intake venting process by a second intake valve opening. The operation is different from Cycle A in that during the intake phase in FIG. 1B-1, the intake valve opens first, and during the consecutive compression phase in FIG. 1B-2, it opens a second time as well, alas for shorter duration and with greatly reduced lift and flow rate. The results of this high-pressure venting are better than that of the low-pressure compression-relief of Cycle G, which boosts NOx. Cycle B boosts efficiency by increasing the expansion-to-compression ratio, and reduces NOx formation dramatically. The process illustrated in FIGS. 1B-1-1B-4 is exemplary to the proposed modified gas Cycle B. Note that the first intake valve opening is labeled 1st in FIG. 1B-1 and the second one is 2nd in FIG. 1B-2, while the venting gas (air) is labeled VEN in FIG. 1B-2.

Attention is now turned to FIGS. 1C-1-1C-4, which, according to the teachings of this invention, illustrate the compression-to-exhaust venting process by a second exhaust valve opening. The operation is different from Cycle A in that during the early compression phase in FIG. 1C-2, the exhaust valve opens first for a short duration and with greatly reduced lift and flow rate, while during the exhaust phase in FIG. 1C-4, it opens for a second time, normally. The results are similar or better than that of the compression venting of Cycle B. The air addition to the exhaust gas further cleans emission by oxidation. A reed valve abutting the exhaust manifold further helps in that oxidation. The process illustrated in FIGS. 1C-1-1C-4 is exemplary to the proposed modified gas Cycle C. Note that the first exhaust valve opening is labeled 1st in FIG. 1C-2 and the second one is 2nd in FIG. 1C-4, while the venting gas (air) is labeled VEN in FIG. 1C-2.

FIGS. 1D-1-1D-4 are similar to FIGS. 1B-1-1B-4, however illustrating the second opening of the intake valve, in the power stroke, thereby venting the expansion phase and dumping some exhaust gas (internal-auto-EGR) into the intake manifold (expansion-to-intake venting). That venting dilutes combustion and thereby greatly reduces NOx formation, alas at the expense of some engine power and torque. When this venting commences upon or right after the normal exhaust valve opening, the power and torque loss is marginal. The process illustrated in FIGS. 1D-1-1D-4 is exemplary to the proposed modified gas Cycles D, I and J, where Cycle I in FIG. 1D-1 is a combination of Cycles G and D, and Cycle J is a combination of Cycles H and D. Again, the first intake valve opening is labeled 1st in FIG. 1D-1 and the second one is 2nd in FIG. 1D-3, while the venting gas (exhaust gas) is labeled VEN in FIG. 1D-3.

FIGS. 1E-1-1E-4 is a combination of FIGS. 1C-1-1C-4 and FIGS. 1D-1-1D-4, illustrating a double venting by second openings of both the intake and the exhaust valves. The result is further NOx reduction at about the same or slightly improved engine performance. The process illustrated in FIGS. 1E-1-1E-4 is exemplary to the proposed modified gas Cycles E. The labels were explained above.

FIGS. 1F-1-1F-4 is a combination of FIGS. 1B-1-1B-4 and FIGS. 1D-1-1D-4, illustrating a triple venting by second and third openings of the intake valve. The result is further NOx reduction at about the same or slightly improved engine performance. The process illustrated in FIGS. 1F-1-1F-4 is exemplary to the proposed modified gas Cycles F. The labels were explained above.

Next, in FIGS. 2B trough 2F, the double and triple lobe cams, which enables the proposed modified gas Cycles B, C, D, E, F I and J, are illustrated and explained. Next to the figure numbers, arrows indicate the firing top dead centers (FTDC) location throughout. The auxiliary (secondary and tertiary) lobe lifts are less than 1/10th of that of the normal lobes. The cams rotate counterclockwise. To ease understanding, the lobes are superimposed on the highlighted cam shaft. The lobe trim angles are exemplary, but approximate.

FIG. 2B illustrates a double lobe intake cam, suitable for gas Cycle B. This is the same as FIG. 2A, but with lobe I3 missing.

FIG. 2C illustrates a double lobe exhaust cam, which is suitable for gas Cycle C. The normal lobe is labeled E1 and the secondary E2. Superimposed dotted is the intake cam with normal lobe (I1). Notice that E2 is almost tangential to (I1). Their corresponding trim angles may match or overlap however.

FIG. 2D illustrates a double lobe intake cam, suitable for gas Cycles D, I and J. The normal lobe is labeled I1 and the secondary one, I2. Superimposed dotted the normal exhaust lobe (E1). Note that the intake trim angle is however extended in Cycle I and shortened in Cycle J, clockwise.

FIG. 2E illustrates a double lobe intake cam, suitable for gas Cycle E. The normal lobe is labeled I1 and the secondary one, I2. Superimposed dotted the normal exhaust lobe (E1) and the secondary exhaust lobe (E2).

Attention is now turned to FIG. 2F, which illustrates a triple lobe intake cam, which is suitable for gas Cycle F. The normal lobe is labeled I1 and the secondary and tertiary lobes and I3 correspondingly. Superimposed dotted the normal exhaust cam lobe, labeled (E1). Notice the common tangent of I1 and I2. Such a common tangent however is not a must.

Next, the behavior of the modified gas cycles will be presented and explained, with emphasis on NOx reduction, cylinder gas pressure and temperature conditions, and power and torque trends.

Eight plots will be presented for each modified cycles (for Cycles B, C, D, E, F, I and J that is). Namely, gas mass-flow-rate and valve lift vs. crank angle (1), low speed log-log pressure-volume (2), pressure vs. crank angle (3), temperature vs. crank angle (4), brake power vs. crank angle (5), brake torque vs. crank angle (6), internal auto-EGR rate vs. crank angle (7), and NOx concentration vs. crank angle (8).

For easy overview and identification, the numbers in parenthesis above will follow the Cycle labels. Thus, for instance, FIG. B3 will illustrate the temperature vs. crank angle plot of gas Cycle B. On the NOx plots (8), the US Tier 4 (same as EU Stage IV) level—to be enforced by 2015—is marked dotted.

Note also that the plots compare the modified cycle responses to the non-modified one (Cycle A). Labels will mark the plots to compare accordingly. The characteristic traits of these gas cycle modifications are grouped and presented next. The plots were returned by GT simulations. GT is common in the industry.

Attention is now turned to FIG. A1, illustrating a Cycle A response for reference. Notice the characteristic differences of the intake and exhaust flows. The exhaust, start with an energetic blow-down. The power-to-intake venting harvests its energy in part. Venting modifies both the intake and exhaust flow rates. See that in FIGS. B1 through F1 and I1 and J1.

Attention is now turned to FIGS. B1 through B8, illustrating the Cycle B responses.

Cycle B lowers low speed pressure, conserves temperature and power, loses some low speed torque, has no significant EGR, and greatly reduces NOx by charge cooling.

Attention is now turned to FIGS. C1 through C8, illustrating the Cycle C responses.

Cycle C lowers low speed pressure, conserves temperature and power, loses some low speed torque, has no significant EGR, and greatly reduces NOx by combustion quenching. This response is very similar to that of Cycle B. Note that plot B8 does not account the effect of oxidation—that is of further emission cleaning—which takes place in the exhaust manifold.

Attention is now turned to FIGS. D1 through D8, illustrating the Cycle D responses.

Cycle D slightly boosts pressure, lowers low speed temperature, conserves power, loses some low speed torque, has an auto-regressive low level EGR, and greatly reduces NOx by combustion dilution.

Attention is now turned to FIGS. E1 through E8, illustrating the Cycle E responses.

Cycle E lowers low speed and boosts high speed pressure, lowers low speed temperature, conserves power, loses some low speed torque, has an auto-regressive low level EGR, and greatly reduces NOx by combustion dilution and quenching.

Attention is now turned to FIGS. F1 through F8, illustrating the Cycle F responses.

Cycle F lowers low speed and boosts high speed pressure, lowers low speed temperature, conserves power, loses some low speed torque, has an auto-regressive low level EGR, and greatly reduces NOx by combustion dilution and quenching. This response is very similar to that of Cycle E.

Attention is now turned to FIGS. I1 through I8, illustrating the Cycle I responses.

Cycle I lowers low speed and boosts high speed pressure, lowers low and high speed temperature, looses low speed and boosts high speed power and torque, has an auto-regressive low level. EGR, and sufficiently reduces NOx by combustion dilution and charge cooling. Note that this gas cycle modification is able to fix the NOx problem of Cycle G (the Atkinson cycle), which, at mid speed, has the same high peak NOx as Cycle A has and much higher yet at higher speeds (not illustrated).

Attention is finally turned to FIGS. J1 through J8, illustrating the Cycle J responses.

Cycle J boosts pressure, lowers low speed and boosts high speed temperature, loses power and torque, has moderate variable EGR level, and reduces NOx extremely by combustion dilution and charge cooling. Note that this gas cycle modification is able to reduce greatly the excessive power and torque losses of Cycle H (the miller Cycle), yet the remaining losses may still remain an unacceptable price to pay for emission cleaning.

One may conclude that compression-to-intake venting, compression-to-exhaust venting, expansion-to-intake venting and their combinations, have similar yet different benefits and drawbacks. In general, all cleans emission in the cylinder extremely well by charge cooling and/or combustion quenching and/or dilution, and thereby it may eliminate the need for exhaust gas after-treatments.

The auxiliary second opening of either the exhaust or the intake valves, or both in combinations, offers extreme simplicity and economy and may substitute NOx after treatment. The second valve openings are best commanded by using double lobe cams. That is extremely simple, economical and hardly disturbs the current engine making technology. It also allows for almost all time lean operation. It adds air to the exhaust gas, which enters the cylinder for cooling, but leaves before combustion commencement. It cools the valves and adds turbulence right when gas mixing is needed. It is also suitable for cam lobe regrinding for emission control of old engines. Venting is not a fuel saving or performance boosting process, but rather an emission cleaning one. Yet, the proposed Cycle I, additional to its emission cleaning capacity, has capacity to either boost torque and power or to save fuel considerably.

The present invention is described above with reference to a preferred embodiment. However, those skilled in the art will recognize that changes and modifications may be made in the described embodiment without departing from the nature and scope of the present invention. For instance, one may use an extra valve for compression-to-environment venting, which is similar to gas Cycle B. One may use that added valve for retaining the vented gas for later reintroduction. The retention may be in a pipeline or in a manifold. Such added means add complexity and cost, but may offer further benefits. For instance, it may boost torque and power at any engine speed. Adding valves is constructive over the teachings of the invention. Also, to replace the intake and exhaust valves with hydraulic, pneumatic or solenoid valves with electronic control, for such valve may also be opened for a second or a third time as needed. And finally, to add small venting lobes to double-lobe cams, which normally controls two two-stroke cycles coupled on common crankshaft.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Internal combustion engine gas cycle modification using at least one of the following venting processes through the cylinder, essentially:
a) from compression phase to intake manifold;
b) from compression phase to exhaust manifold;
c) from expansion phase to intake manifold; and
d) from exhaust phase to intake manifold,
whereas said venting enables some low level automatic gas transfers from said phases to said manifolds by at least one opening, additional and auxiliary to the normal opening, of at least one of the following valves:
e) intake valve; and
f) exhaust valve,
whereas said additional opening is enabled by at least one additional lobe, added to the cam of said valves, and
whereas said additional lobes are auxiliary, smaller than normal lobes, allowing for a short-duration, small-lift valve opening only,
and
whereas said gas cycle is one of the following class:
g) Otto;
h) Diesel,
i) Atkinson; and
j) Miller,
and
whereas said gas cycle is one of the following kind:
k) four-strokes, and
l) two-strokes,
and
whereas said engine is one of the following type:
m) single-cylinder, and
n) multi-cylinder.

2. Process as per claim 1, whereas at least one of said manifolds comprise at least one check valve of low resistance.

3. Process as per claim 1, whereas said venting is a combination of b) and c) having double lobes on the valves e) and f).

4) Process as per claim 1, whereas said venting is a combination of a) and c) having a triple lobe on valve e).

5) Process as per claim 1, whereas at least one of said auxiliary lobes is tangential to said normal lobe.

6) Process as per claim 1, whereas at least one of said auxiliary lobes overlaps with said normal lobe.

7) Process as per claim 1, whereas said venting processes c) and d) overlap.

8) Process as per claim 1, whereas said engine has cam-less valves, which allow for said venting process.

9) Process as per claim 1, whereas said lobes, added to the normal lobes, are added as engine retrofit.
